(19) United States
(12) Patent Application Publication
(10) Pub. No.: US 2014/0217038 A1
(43) Pub. Date: Aug. 7, 2014

(54) SATURATION LIMITED FEEDER FOR CHEMICAL ADDITIONS

(71) Applicant: Evapco, Inc., Taneytown, MD (US)

(72) Inventors: John W. LANE, FINKSBURG, MD (US); Sarah L. FERRARI, Mount Airy, MD (US)

(73) Assignee: Evapco, Inc., Taneytown, MD (US)

(21) Appl. No.: 14/075,300

(22) Filed: Nov. 8, 2013

Related U.S. Application Data
(60) Provisional application No. 61/723,926, filed on Nov. 8, 2012.
(60) Provisional application No. 61/828,824, filed on May 30, 2013.

(51) Int. Cl. C02F 1/68; C02F 1/50

(52) U.S. Cl. CPC C02F 1/688; C02F 1/50; C02F 2303/04; C02F 2103/023
USPC 210/764; 210/198.1; 210/140; 210/141

(57) ABSTRACT

A chemical feed method and apparatus that uses the solubility limit of a specific chemical to provide a measured dose. The invention includes a container of a specific volume into which a solid chemical is placed and held. The chemical dissolves until it approaches its solubility limit. When the system requires a dose of chemical, the container is flushed and a controlled dose of the chemical is fed in to the system. The invention can be combined with kinetic dissolution to allow a larger dose from a given feeder.

### CROSS-REFERENCES TO RELATED APPLICATIONS

This application claims the priority benefit under 35 U.S.C. §119(e) of U.S. Provisional Application Ser. No. 61/723,926, entitled “SATURATION LIMITED FEEDER FOR CHEMICAL ADDITIONS,” filed Nov. 8, 2012, and U.S. Provisional Application Ser. No. 61/828,824, entitled “SATURATION LIMITED FEEDER FOR CHEMICAL ADDITIONS,” filed May 30, 2013, both of which are incorporated herein by reference in their entirety.

### BACKGROUND OF THE INVENTION

1. Field of the Invention

The present invention relates to a system for additions of solid chemicals to liquid systems. More particularly, the present invention is directed to a method and apparatus to slug feed solid chemicals into a system.

2. Background of the Prior Art

Evaporative cooling equipment dissipates heat by evaporation of some of the recirculated cooling water. The water in the recirculated-loop is warm and open to the atmosphere. One issue with such systems is the tendency for biological growth to occur. This biological growth can impede heat transfer, aggravate corrosion, and may even harbor human pathogens. To control biological growth in cooling equipment, liquid biocides are often pumped into the recirculating loop.

Using liquid biocides increases the potential for environmental accidents. Spills and leaks can occur while handling and pumping the toxic biocides resulting in contamination of the environment. Solid biocides are preferred to liquids since the chance for a concentrated liquid spills is eliminated and handling of solids is usually easier than handling concentrated liquids. There are several ways in the prior art to use solid biocides with an automatic feed. The simplest consists of placing soluble tablets in a floating device with a mesh bottom and placing the float into a basin. U.S. Pat. Nos. 3,792,979 and 4,241,025 are two examples of this type of device. An alternative method is described in U.S. Pat. Nos. 4,858,449 and 5,928,608 where the tablets are placed in a canister and a spray is directed at the tablets to slowly dissolve the chemical. Yet another method is described in U.S. Pat. No. 6,739,351 where the chemical is placed in a holding vessel and a controlled flow of liquid is passed through the chemicals. All of these devices attempt to control the release of solid chemicals by controlling the kinetics of dissolution, i.e., the length of time that the water is flowing through the feeder and the water velocity. The release from this type of equipment will be variable unless the equipment is very carefully controlled. A modification of these devices is found in U.S. Pat. No. 6,418,958 where the spray containing the dissolved liquid is collected in a tank. The spray is recirculated until the liquid reaches a pre-set conductivity limit. The concentrated liquid is then pumped into the system like any other concentrated liquid chemical.

When feeding a solid chemical using the prior art, the dissolution of the solid chemical relies on the kinetics of the dissolution process. Thus, if the feed is controlled by an erosion process, in which the rate at which chemical is released is based on the flow rate and the diminishing surface area of the chemical block, the flow rate and surface area of the chemical will determine how fast the chemical is released. Other devices use different techniques, such as conductivity controllers, to attempt to control this variable release but the equipment is complex and prone to breakdown. The chemical itself can clump and bridge which also affects the dissolution rate of the chemical.

In general, these prior-art systems are suited for a continuous or semi-continuous release of chemical in which the chemical is released over an extended period of time. However, many biocides are most effective when a high dose is slug-fed for a short period of time. To administer such biocides under current (prior art) systems, blowdown of the system is stopped and a high quantity of biocide is fed to the system. The blowdown is kept off for a short period of time allowing the biocide to work. After the biocide is allowed to work, blowdown is resumed, and the biocide will slowly bleed from the system. Besides the biocides being more effective in a high dose for a short period of time, overall less biocide is used under such a slug-feed program than with a continuous-release program. Thus using a slug-feed program will result in less biocide being used and eventually being released into the environment. Because of the slow release rate of the prior art techniques, solid biocides cannot easily be used for automatic slug feeding.

### SUMMARY OF THE INVENTION

The present invention relates to a saturation limited feed system for automated or semi-automated additions of solid chemicals to liquid systems. More particularly, the present invention is directed to a method and apparatus to slug-feed solid chemicals into a circulating liquid system. The method and apparatus can be used to add any suitable chemical to any suitable system, but the invention is described specifically for the addition of a biocide to the recirculating water of a cooling system.

The present invention does not use kinetics to control the dissolution of the solid chemical; instead the invention relies on the solubility of the solid chemical in the liquid. The solubility limit of a chemical in a solution is defined as the maximum amount of chemical that can be dissolved in that solution at a specific temperature. The solubility limit is usually given as a percentage (e.g., 1%) or as grams of chemicals that can be dissolved in a liter of solution (e.g., 1%=10 g/liter). Once a solution is at its solubility limit, additional solid chemicals added to the solution will not dissolve. In accordance with a preferred arrangement of the invention, a basket constructed from a plastic mesh is located inside a water impermeable container. For simplicity the water impermeable container will be referred to herein alternatively as slug pipe, a holding tube, or as PVC pipe, though any water impermeable container made from an appropriate plastic, metal, fiberglass, or other material will be suitable. Nor does the container need to be in the shape of a pipe or tube as any shape container will also be suitable. Likewise the basket mesh will be referred to as a basket fabricated from some suitable plastic such as polypropylene; however, any appropriate material can be used for the basket.

The invention functions by loading an excess of chemical into the mesh basket and placing the mesh basket into the PVC pipe. The PVC pipe is filled with a specific volume of water and the chemical and water are allowed to stay in contact for a period of time. During this time, the chemical dissolves until it approaches its solubility limit. At this point, no additional chemical will dissolve into the water. When there is a need for a slug of chemical, a valve or series of valves is opened and water flows through the slug pipe displacing the chemical-saturated water with unsaturated water. The flush typical lasts for only a few minutes; little additional chemical is dissolved by the small amount of excess flush water. The dosage of the chemical is accordingly determined by the volume of the water in the slug pipe times the solubility of the chemical. With this invention, the dosage of the solid chemical is controlled by the chemical's solubility equilibrium rather than the kinetics of dissolution as used in the prior art. The control mechanism for opening the valve for biocide addition to a cooling tower is preferably a timer-controlled valve; however, other methods to control the chemical release are known, and are also considered part of the invention. Some of these alternative-means to activate the flush are:
1) A make-up or blowdown water totalizing meter where when a specific quantity of water has been measured then the chemical is dosed.
2) A step in a program, for example in a cleaning cycle for a laundry, where chemicals are dosed at a particular stage of the process.
3) A response to a measured value of the system. For example, the valve could be activated whenever an ORP value falls below a pre-set value.
4) Any point that indicates that the system needs an addition of chemical can be used as a signal to actuate the valve.
5) Manually activating the valve.

Another advantage of the present invention is its ease of scale-up from adding a small amount of chemicals to adding a very large amount of chemicals. The quantity of chemicals contained in a flush is simply the solubility of the chemical times the volume of the slug pipe. If a small amount of chemical is needed, the invention can be configured to place only a small volume of water in contact with the chemical. If a larger quantity of chemical per dose is needed then the only required change is that a larger volume of water is maintained in contact with the chemical, i.e., a larger slug pipe is used. Besides varying the size of the container, the varying quantity of chemical dosing can be achieved by configuring the system with a large volume slug pipe, and using inert objects to displace water in the container, using various liquid heights in a container by varying the height of the output connection, or by other methods and systems known to persons having ordinary skill in the art.

### BRIEF DESCRIPTION OF THE DRAWINGS

FIG. 1 is a cut-away representation of an embodiment of the invention

FIG. 2 is a side perspective illustration of a mesh basket according to an embodiment of the invention.

FIG. 3 is a representation of the embodiment shown in FIG. 1, showing one embodiment of water flow and valve settings during discharge of chemical to the system.

FIG. 4 is a representation of the embodiment shown in FIG. 1, showing one embodiment of water flow and valve settings for draining the holding tube after the tube has fed a chemical slug to the system.

FIG. 5 is a side cutaway representation of an embodiment of the invention, showing chemical in the basket.

FIG. 6 is a side cutaway representation of an embodiment of the invention showing the use of inert material to reduce the volume of water in the holding tube.

FIG. 7 is a side cutaway representation of another embodiment of the invention.

### DETAILED DESCRIPTION OF THE INVENTION

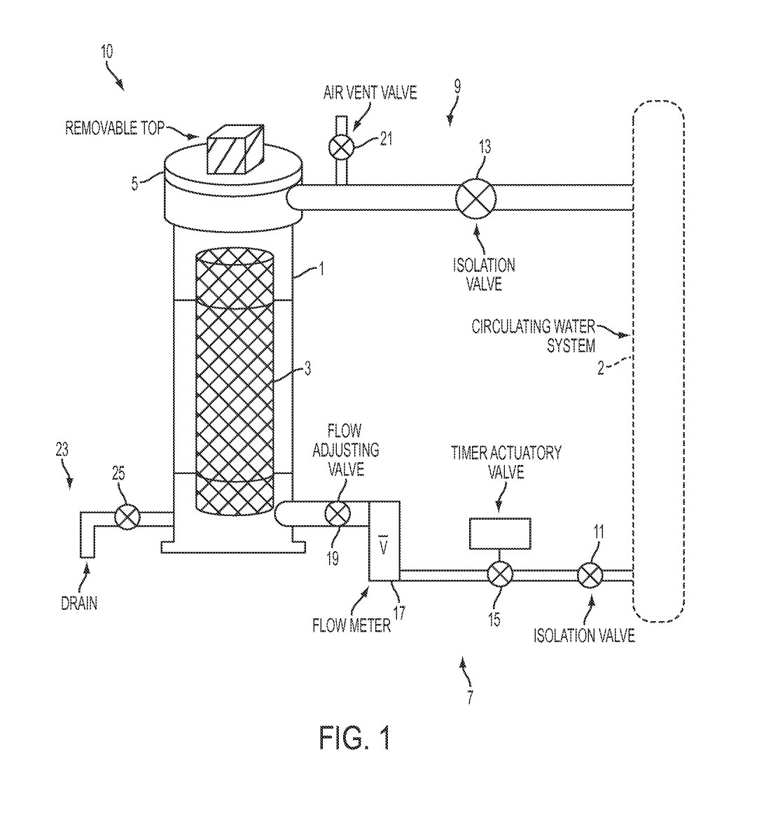

FIG. 1 illustrates the general layout of a slug feed loop 10 according to one embodiment of the invention. Section of pipe 1 (also referred to herein as slug pipe or holding tube) is configured to receive removable basket 3. According to one embodiment, the section of pipe is construction of PVC, and the basket is wire or plastic mesh. Slug pipe 1 is fitted with a removable top 5 to allow addition of chemical to the slug pipe and/or removal of the basket 3. Slug pipe 1 is connected to a circulating water system 2 by sections of pipe 7, 9. Sections of pipe 7, 9 may be fitted with isolation valves, 11, 13, and one or more of timer actuating valve 15, flow meter 17, flow adjusting valve 19 and air vent valve 21. Slug pipe 1 may also be fitted with drain section 23, including drain valve 25.

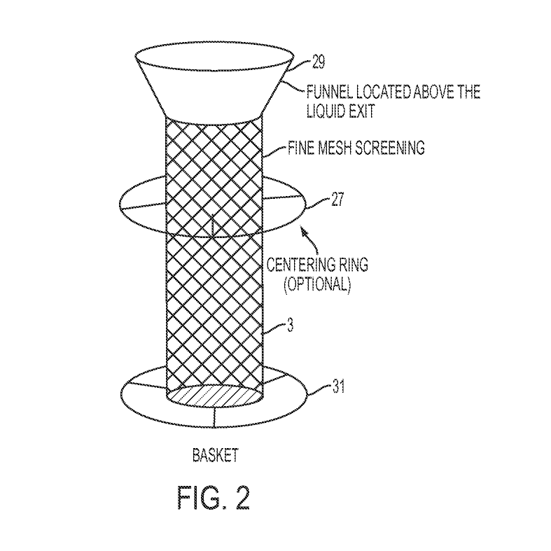

FIG. 2 shows a close-up of basket 3, optionally fitted with centering ring 27 and optional funnel 29. Basket 3 is also optionally fitted with a wide base 31, comprising a disk or ring, the diameter of which is slightly less than the inside diameter of the slug pipe 1. Centering ring 27 is configured to prevent the basket from tipping while inside the slug pipe 1. Optional funnel 29 may be permanent, semi-permanent, or removable, and is configured to allow easy addition of chemical.

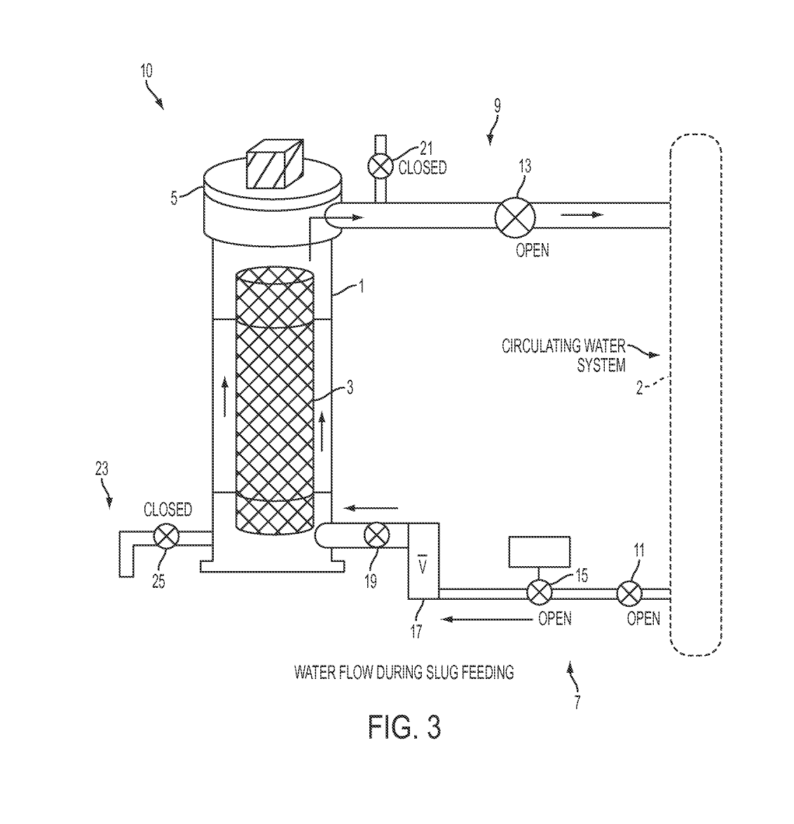

FIG. 3 illustrates one embodiment of the invention in which chemical is slug fed to the circulating water system 2 with isolation valves 11, 13, open, timer actuating valve 15 open, flow adjusting valve 19 open, and air vent valve 21 closed and drain valve 25 closed. According to one embodiment, water flow through the slug feed loop occurs by actuation/opening of the timer-controlled valve 15, and the flow rate is preset by the adjusting valve 19 with feedback from the flow meter 17. When the timer-controlled valve is opened, water moves through the slug feed loop displacing the chemically saturated water in the slug pipe 1. After a suitable time, usually one to five minutes, and in any event whatever time is considered sufficient to fully flush the chemically saturated water from the slug pipe, the timer-controlled valve closes.

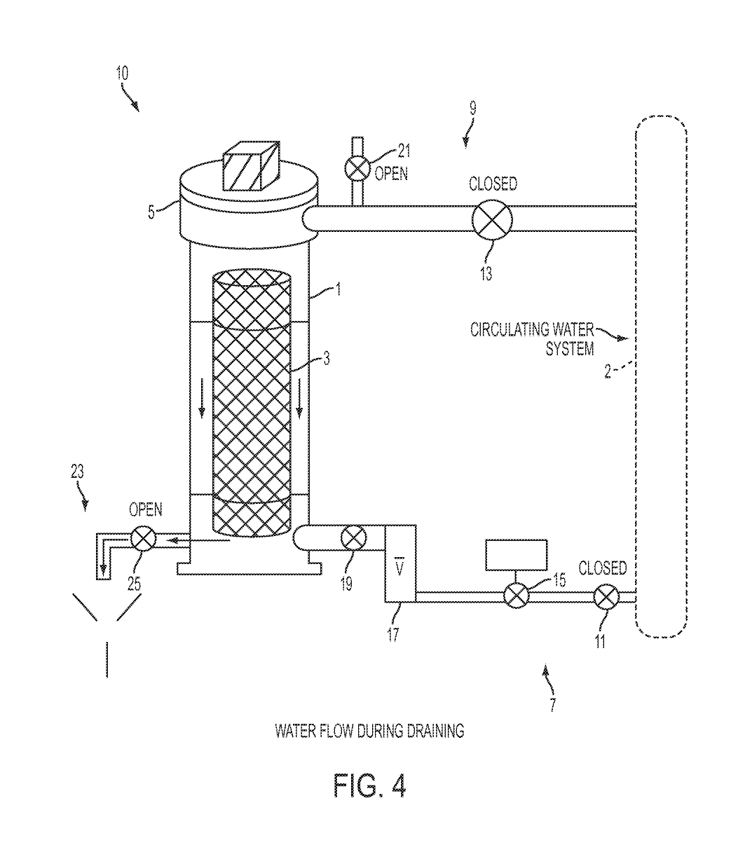

FIG. 4 illustrates an embodiment of the invention according to which the slug pipe 1 may be drained or partially drained to allow addition of solid chemical to the basket 3. According to preferred embodiments, the system may be purged shortly before chemicals are added to the system. According to this embodiment, isolation valves 11, 13 are closed and drain valve 25 and air valve 21 are opened, and the slug pipe 1 will quickly drain. After some or all of the water is drained from the slug pipe 1, removable top 5 may be removed and chemicals may be added to the basket 3.

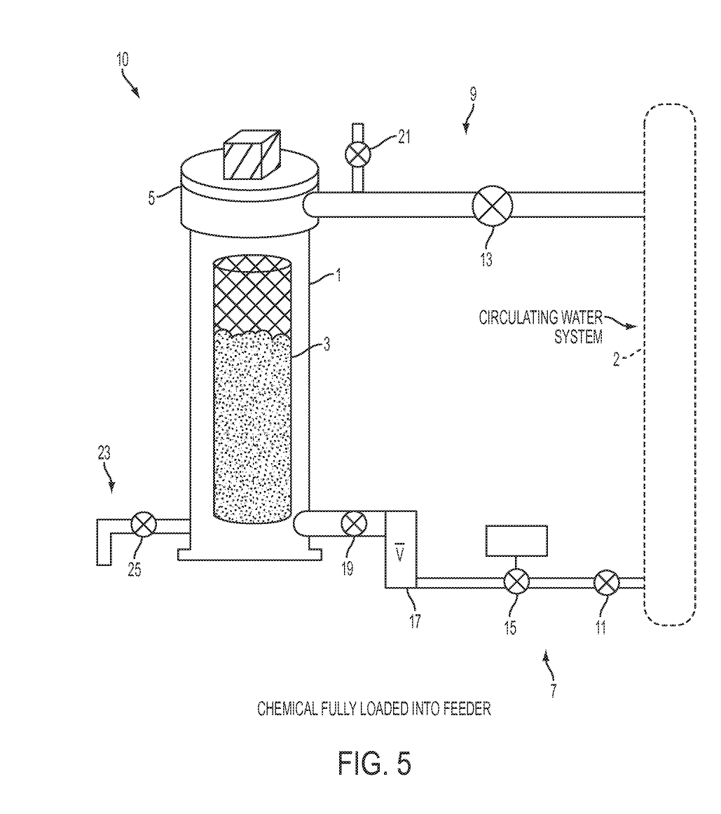

Referring to FIG. 5, the form of the chemical used in the basket/slug pipe can be any type of solid, including granulated, powdered or tablets. The form of the chemical is important for ease of loading, but does not dramatically affect the function of the invention. However, for the invention to work as intended, the amount of solid chemical in the basket must equal or exceed the maximum amount of chemical that will dissolve in a volume of water equal to the internal volume of the slug pipe, minus the volume of the solid chemical in the slug pipe.

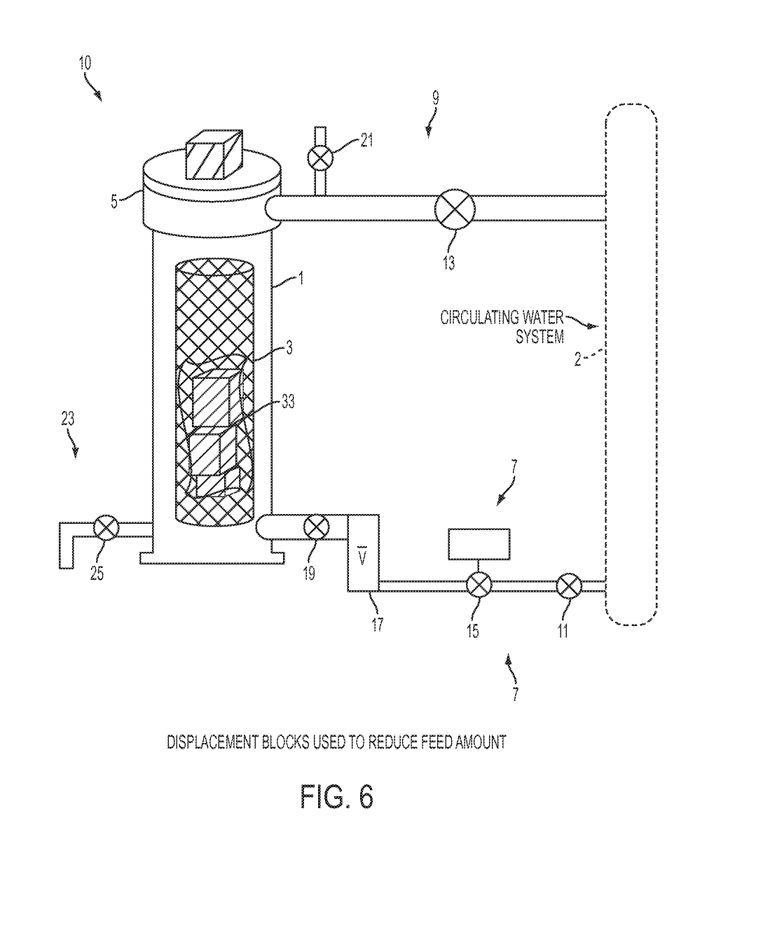

As the invention relies on the solubility limit of the chemical, and the addition of different amounts of chemical to the circulating system 2 may be desired under different various conditions, and different chemicals have different solubility limits, the invention provides a simple method for adjusting the amount of chemical added in a single slug feed. As shown in FIG. 6, volumes of inert material 33 may be added to the slug pipe 1, inside, beneath, or around the basket 3, in order to reduce the volume of water in the slug pipe 1. According to this feature of the invention, the volume of liquid in the slug pipe may be reduced for chemicals with a higher solubility limit or a lower dosage amount, without having to reduce the size of the slug pipe. Therefore, according to a preferred embodiment, the slug pipe is configured to hold a volume of water that will dissolve the desired the amount of a chemical having the lowest solubility limit among the various chemicals that might be added to the system. When chemicals having higher solubility limits are to be added or a lower dose of chemical is desired, the inert materials may be added to the slug pipe to reduce the volume of water in the pipe so that the appropriate amount of chemical for a single slug may be dissolved.

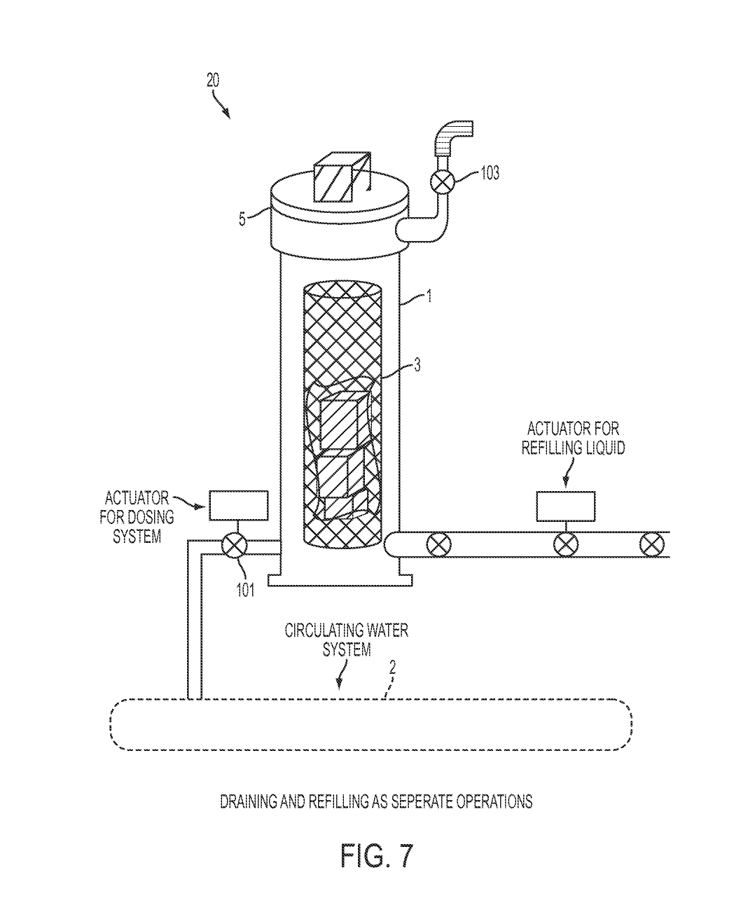

FIG. 7 shows an alternative embodiment of a slug feed system 20 according to the invention in which the chemical slug is gravity fed to the circulating water system 2. According to this embodiment, when a slug of chemical is to be added to the circulating water system 2, actuator valve 101 is opened, and air-release/vacuum-breaker valve 103 opens, allowing the volume of water in the slug pipe 1 to flush into the circulating water system 2 under action of gravity. Once the slug pipe has been flushed into the circulating water system, actuator valve 101 is closed, and refilling valve 105 is opened to refill the slug pipe with a new volume of water. The system may be configured to receive the new volume of water from the circulating water system 2, from a different source of water (e.g., a tank, a well), or from a combination thereof. According to this embodiment of the invention, the dosing of the saturated liquid in the slug pipe into the circulating water system, and the refilling of the slug pipe with unsaturated liquid are two separate operations.

### EXAMPLE 1

DBNPA is a non-oxidizing biocide that is commonly used to control microbiological activity in cooling towers. DBNPA has a solubility limit in room-temperature water of about 1.0%. DBNPA is preferably slug-fed at a dosage of about 10 ppm based on the water volume of the system. A typical treatment program consists of dosing DBNPA 3 times per week (13 times per month). On a monthly basis the chemical feed system is inspected and the chemicals in the feeder are recharged. A water system having a volume of 1000 gallons requires a dose of 37.8 grams of DBNPA to be treated at the 10 ppm level. This treatment is accomplished by slug feeding 3.8 liters of water saturated (1.0%) with DBNPA. This dosage is administered as a slug feed over the course of a few minutes.

A 4″ diameter pipe holds approximately 200 ml of water per inch, thus a water-filled length of pipe that is about 19 inches long holds 3.8 liters. The actual device would be somewhat larger to include additional volume for holding at least 13×37.8=491 grams of DBNPA. A 2′/2″ diameter mesh pipe 13 inches in length holds over 1000 grams of DBNPA, sufficient for 13 slug feeds at 37.8 grams with 100% excess.

DBNPA has close to an ideal solubility for this invention. The chemical is soluble enough that a very large water volume and hence a large pipe is not required for a typical dose. Yet, at 1.0% solubility, it is not so soluble that the dissolving of the chemical with each dose would dramatically increase the volume of water and thus increase subsequent dosages. This allows a large number of doses to be done from a single charge. If the density of the DBNPA is equal to that of water, the variation in volume of saturated water with each dose over the period of a month will be less than 10% of nominal.

A more soluble chemical can also be used with this invention; however the number of doses will be limited. Likewise a less soluble chemical could be used but the water volume of the feeder would need to be increased to get a similar dose.

Table 1 illustrates the consistency of results that was obtained from testing with a small scale device. The device consisted of a 3.0 liter plastic container surrounding a tube fabricated from 400-mesh polypropylene. 600 grams of DBNPA powder were added to the mesh-tube. After various soak times, 1 gpm of water was flushed through the feeder for 2 minutes. The total amount of DBNPA was then measured.

TABLE 1
Small-Scale Saturation Limited Feeder Results

| | Grams of DBNPA |
|---|---|
| Soak Time in hours | Released |
| 48.3 | 37.1 |
| 25.0 | 39.2 |
| 71.7 | 37.1 |
| 23.3 | 30.5 |
| 24.1 | 34.4 |
| 23.7 | 30.5 |
| 24.4 | 33.2 |
| 66.8 | 34.5 |

The average quantity of chemicals released was 34.6 grams with a standard deviation of 3.1 grams. Depending on the arrangement of a specific feeder and density of the dissolved chemical, the feeder may perform more consistently with the basket elevated and containing a mesh bottom and/or with the sides of the basket masked to allow a more consistent water/chemical interface regardless of the quantity of chemical in the feeder.

The invention as shown and described with respect to FIGS. 1, 3, 4, 5 and 6 has the slug-feed of the chemical and the addition of new liquid occurring as a single flush operation. However, according to a different embodiment, shown for example in FIG. 7, the slug-feed may be performed by opening a valve and allowing the saturated water to drain out by gravity. After draining, the slug pipe may be refilled with unsaturated water. An automatic air-release/vacuum-breaker valve is helpful in this arrangement. This arrangement has the advantage that there is no excess purge water that could carry a small amount of additional chemical. The limitation with this embodiment is that the saturated chemical must be fed at an unpressurized point in the system.

The invention also does not require an internal basket as the chemical can simply sit in the slug pipe so long as the configuration of the slug-pipe and flow of the saturated liquid inhibits solid chemicals from leaving the container. Having a mesh basket allows equilibrium to be reached faster and limits the amount of solid chemical carryout when flushing over a large range of flushing velocities.

This invention can be combined with a kinetic feeding step to provide additional dosing, if necessary. This part of the treatment will have the same issues as prior art devices, particularly the control of release rate. However, much of the required dose will be accurately provided by the saturation dosing therefore the impact of the variability of the kinetic dosing will be less. Making the device into a combination saturation and kinetic feeder could simply be done by allowing the purge water to flow for a controlled length of time at a specific flow rate for more than required to purge the system of saturated chemicals. The amount of the additional kinetic-dose can be controlled by adjusting either the flow rate, the length of time of the kinetic-feed flow, or both. In addition, since much of the dose is provided with the first flush, the time required to supply the full dosage is short enough to allow slug feeding of the chemical.

By adding this kinetic step, a single feeder size could treat a broad range of systems. A specific feeder will have a specific volume of water and thus release a specific amount of chemical when the water becomes saturated. That amount of chemical will be appropriate for a specific size of cooling system. For smaller systems, inert material can be added to the feeder. This inert material will reduce the volume of water in the feeder and hence the amount of chemical released. For larger systems, a kinetic release step can be added. By controlling the length of time and the water velocity for this step, larger systems can be adequately treated. Thus a broad range of chemical dosing can be done from a single feeder.

As an example, tests were run using a 6″ diameter feeder containing 20 liters of water and the release rate, without any soak time, was measured. Operating for 30 minutes at a 4-gpm rate through the feeder (displacing 23 times the water volume of the feeder) 130 grams of chemical were released. This kinetically-controlled release is in addition to the chemical that would be released had the feeder been allowed to soak. A purely saturation-based release would result in the dissolution of 10 grams per liter of DBNPA or a 200 gram dosage. The kinetic addition step thus increases the dose of chemical for a single release to 330 grams. A 200 gram dose of DBNPA will treat 5,280 gallons at a 10 ppm level; a 330 gram dose will treat 8,700 gallons. Using the rule of thumb that the water volume of an evaporative cooling system is equal to 10× the tonnage, a purely saturation limited feeder with a 20 liter volume can treat up to a 500-ton system. The addition of the kinetic release step above increases the size of the system that can be treated with a single feeder from 500 tons to over 800 tons.

This invention could, in addition, be used for a monthly single-shot dose of a different, compatible, and highly-soluble chemical. For example, by adding a quantity of a compatible, highly-soluble biocide or biodispersant to the invention when it is being refilled with a biocide, the first release will contain both the multiple-slug-fed biocide and the highly-soluble biocide or biodispersant. Such dosing can be effective at preventing bacteria resistant to the primary biocide from becoming established or aiding in the removal of biofilm. As an example, if the multiple-slug-fed chemical is DBNPA the highly-soluble chemical could be isothiazoline. Isothiazoline is available as a solid, is highly soluble, and is compatible with DBNPA. The exact amount of isothiazoline required for a single dose could be added to the feeder once per month when the feeder is being refilled. The isothiazoline would completely dissolve during the first holding period and that dose would be released along with the DBNPA the first time that the system is slug-fed.

What is claimed is:

1. A chemical feeder apparatus connected to a circulating water system, the chemical feeder apparatus comprising:
a container with liquid impermeable outer casing having a liquid inlet, a liquid outlet, and an opening to allow addition of solid chemicals; said container configured to hold a specific volume of liquid;
said container configured to receive a chemical such that the chemical is in intimate contact with the liquid for sufficient time to allow a portion of said chemical to become dissolved in said liquid and for said liquid to become saturated with said chemical;
a control mechanism configured to allow saturated liquid in the impermeable container to flow into the circulating water system and to replace the saturated liquid with unsaturated liquid,
wherein undissolved solid chemical is inhibited from leaving the liquid impermeable container.

2. An apparatus according to claim 1, wherein said chemical is located in a liquid porous container located within the impermeable container, said liquid porous container configured to allow intimate contact of the chemical with the liquid.

3. An apparatus according to claim 2, wherein said liquid porous container is fabricated containing a mesh.

4. An apparatus according to claim 3, wherein said liquid porous container has a funnel.

5. An apparatus according to claim 1, wherein said liquid impermeable container is fabricated from PVC or other plastic.

6. An apparatus according to claim 1, wherein said control mechanism comprises at least one valve which allow unsaturated liquid to enter the impermeable container and flush the saturated liquid into the circulating water system.

7. An apparatus according to claim 1 wherein said control mechanism comprises at least one valve which allows the saturated liquid in the impermeable container to gravity drain into the circulating water system by gravity.

8. An apparatus according to claim 6 wherein said control mechanism comprises a timer.

9. An apparatus according to claim 7, wherein said control mechanism configured to periodically remove the saturated liquid comprises a step in a program.

10. An apparatus according to claim 8, wherein said control mechanism is configured to automatically cause said flush to occur at least once per week.

11. An apparatus according to claim 8, wherein said control mechanism is configured to automatically cause said flush to occur at least once per month.

12. An apparatus according to claim 1 where inert objects are added to the liquid impermeable container to displace liquid and thus modify the specific volume of liquid that said container can hold.

13. An apparatus according to claim 6 where said flush extends for a longer period of time than necessary to replace the saturated water allowing additional chemical to be released.

14. An apparatus according to claim 1 where a second highly-soluble chemical is added in addition to the first chemical for a single-shot dose of said second chemical.

15. An apparatus according to claim 14 where said first chemical is DBNPA and said second highly soluble chemical is isothiazoline.

16. A method for repeatedly adding chemicals to a circulating water system, comprising:
combining a fixed amount of liquid with an excess quantity of chemical;
holding the liquid and chemical in intimate contact for a period of time in a container such that the liquid becomes saturated with the chemical;
purging the saturated liquid from the container into the circulating water system resulting in a specific slug dose of chemical;
replacing the saturated liquid with unsaturated liquid.

17. The method of claim 16 where the chemical is contained in a porous container.

18. The method of claim 16 where both the purging of the saturated liquid and the replacing with unsaturated liquid is accomplished by flushing the saturated liquid from the container with unsaturated liquid.

19. The method of claim 16 where the purging of the saturated liquid and the replacing with unsaturated liquid is accomplished in two separate operations.

20. The method of claim 16 where the quantity of purge is increased to allow additional chemical to be dissolved and released during each treatment.

21. The method of claim 16 where a second highly-soluble chemical is used, said second chemical being substantially completely released with the first dosing of the first chemical.
